(19) United States
(12) Patent Application Publication
(10) Pub. No.: US 2003/0145750 A1
(43) Pub. Date: Aug. 7, 2003

(54) Print cutter calibration method and apparatus

(76) Inventors: Terence Chee Sung Chang, Poway, CA (US); John F. Manard JR., San Diego, CA (US)

Correspondence Address: Stephen B. Salai, Esq., Harter, Secrest & Emery LLP, 1600 Bausch & Lomb Place, Rochester, NY, 14604-2711, US

(21) Appl. No.: 10/066,236

(22) Filed: Feb. 2, 2002

(51) Int. Cl. B41F 1/54

(52) U.S. Cl. 101/484

(57) ABSTRACT

A cutter having a plurality of stepper motor driven rollers has various components needing calibration to insure that a sheet printed with a plurality of images is properly positioned with respect to the cutter for cutting the sheet into individual prints. A calibration print having a plurality of fiducial marks is used to calibrate various components. These include adjusting the intensity of scanners used by the cutter to locate the prints, to adjust the linear distances the print is moved by drive rollers and to determine precisely the distance between critical components of the cutter.

### TECHNICAL FIELD

The present invention relates to the calibration method and apparatus for the cutter of a photofinishing operation. More particularly, the invention relates to a method and apparatus for calibrating and correcting parameters of the cutter that may change over time.

### BACKGROUND OF THE INVENTION

In photofinishing operations it is conventional to develop and print photographs on roll stock photographic paper having a width that generally accommodates one size of print. After printing out a roll of photos on a strip of the roll stock, the strip is cut to provide the individual prints. Advancements in photofinishing allow for the production of photographs by inkjet printers, laser printers and other photofinishing printers including silver-halide systems that receive digital input and employ conventional wet chemistry output. The use of computers in connection with these advancements allows for further improvement. For example, it is not necessary to use roll stock having the width of a desired finished photo. A photofinishing printer such as an inkjet printer now can generate photos of various sizes on a single sheet of print media. Also the images can be manipulated to nest various image sizes on a single larger sheet. Accordingly, a sheet or roll stock of a single width can be used to generate prints of various sizes for a single customer order.

Printing accomplished by an ink jet printer or the like directed by a computer, generally arranges the individual printed images in rows across the print medium such as a photographic paper. The sheet containing one or more rows of prints representing a customer's order is then fed to a cutter. The cutter uses certain fiducial marks on the sheet to locate cut lines for cutting individual prints form the larger sheet. The fiducial marks are located known distances from the prints because the marks are applied by the inkjet printer contemporaneously with the printing of the photographic images.

Various drives are employed to deliver a sheet from the printer to the cutter and to transport the sheet through the cutter. These drives preferably comprise a system of drive rollers driven by stepper motors and must be calibrated periodically in order to insure that the sheet is properly located for cutting into individual prints. For example, once the cutter locates a fiducial mark, a drive moves the sheet a certain fixed distances to locate an edge of a print at a proper cutting location. If the drive is out of proper calibration, the “fixed” distance it moves the sheet may not correspond to a desired or previously calibrated distance. This may happen because parameters may change over time so that rotation of the roller through a given arc does not translate to a desired or previously set linear distance.

Any one of several factors can alter the calibration of a drive. The diameter of a drive roller can decrease because of wear or the accumulation of deposits on a roller can increase its diameter. Drive gears can wear and manufacturing tolerances of cutter components can alter the operational characteristics of a given cutter over time.

Accordingly, an object of the present invention is to provide a method and apparatus for calibrating the drive of a cutter mechanism used in a photofinishing operation.

Another object of the invention is to provide a calibrating method and apparatus relying upon a printer generated calibrating print for adjusting the drive of a cutter mechanism used in a photofinishing operation.

### SUMMARY OF THE INVENTION

In accordance with the present invention, the various drives associated with the cutter are controllably driven by stepper motors or the like wherein each increment of the stepper motor initially is set to translate into a defined increment of linear movement of a sheet through the cutter. A calibration print produced by the printer of the system is used to calibrate the various drives associated with the cutter. In this respect the calibration print contains certain fiducial markings spaced known distances apart. The calibration print is run through the cutter and the known distance between the fiducial markings is compared to the corresponding distances indexed by the cutter drives. A comparison between the known distances on the calibration print and the actual distance the print is moved by a specific cutter drive is used to provide feedback information. The feedback information in turn is relied upon to correct the amount of rotational movement that is needed to provide an increment of linear movement of the particular drive. Both the determination of the correction needed and the implementation of the correction can be accomplished either manually or by automatic means.

Accordingly, the present invention may be characterized in one aspect thereof by a method for calibrating at least one adjustable drive of a cutter associated with an image printer comprising:

a) setting the adjustable drive to a first setting;

b) printing a calibration print with the image printer;

c) moving the calibration print with the adjustable drive of the cutter;

d) comparing a chosen feature of the calibration print to the distance that the print is moved by the adjustable drive;

e) deriving an input signal representative of the difference between the chosen feature and the distance that the calibration print is moved by the adjustable drive; and

f) correcting the adjustable drive responsive to the input signal.

### DESCRIPTION OF THE DRAWINGS

FIG. 1 is a schematic perspective view showing the components of the present invention;

FIG. 2 is a schematic view showing in elevation a first portion of FIG. 1 on a larger scale;

FIG. 3 is a view similar to FIG. 2 only showing a second portion of FIG. 1 on a larger scale;

FIG. 4 is a plan view showing a calibration print used in the practice of the method of the present invention; and

FIGS. 5-10 are diagrams showing various steps in the calibration method of the present invention.

### DETAILED DESCRIPTION OF THE INVENTION

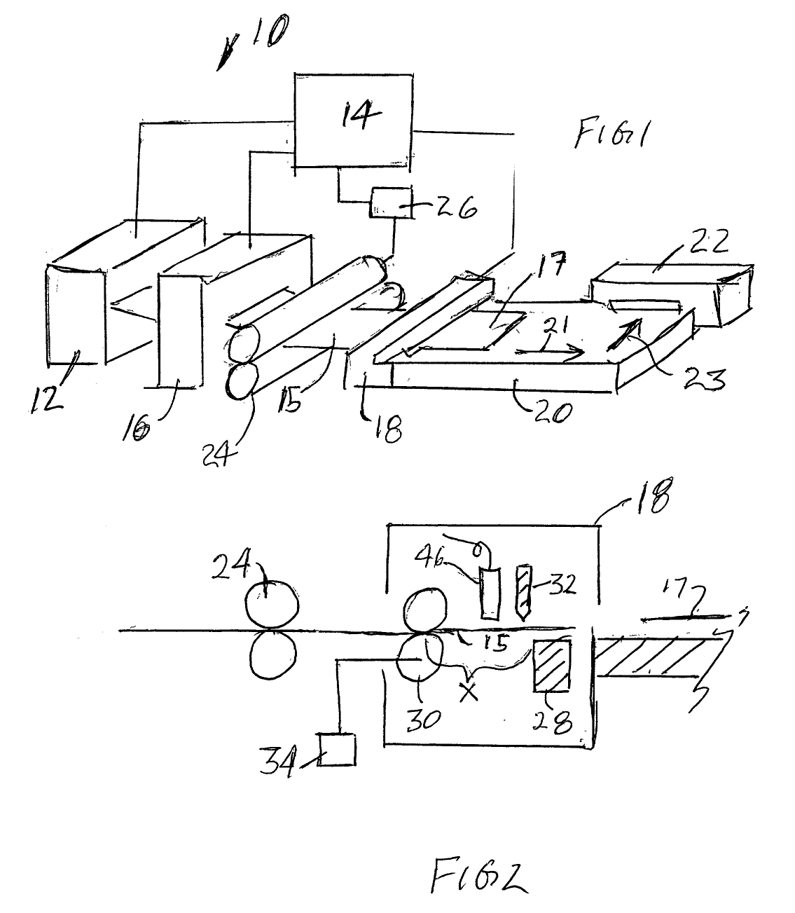

Referring to the drawings, FIG. 1 shows an over view of the components of a photofinishing operation generally indicated at 10. The components include a photofinishing printer 12 such as an inkjet printer or the like. The printer is fed preferably from a continuous roll of photographic paper (not shown). The printer receives instructions from a controller 14 that determines the layout of the individual photographic images on the printed sheet.

From the printer, the printed sheet is delivered to a buffer 16 and then to an entry cutter 18. Since the printer may produce sheets of different lengths and may operate at a different speed than the cutter, the buffer is able to accommodate sheets of various lengths and deliver them in an appropriate spaced apart relationship to the cutter. Entry cutter 18 operates to cut a printed sheet 15 into transverse strips 17, each strip representing a row containing one or more photographic prints. Each strip 17 then is transported longitudinally along a table 20 in the direction of arrow 21 to the far end of the table. At the far end of the table, the strip of prints is moved transversely across the table in the direction of arrow 23 to an exit cutter 22. The exit cutter then severs the strip of photographs into individual prints. The various drivers for moving the printed sheet as described hereinbelow are under the control of the controller 14, which includes the software controlling the drivers. In accordance with the present invention the software has adjustable settings controlling the operation of the various drivers. These settings are first set and then are adjusted as necessary in response to selected inputs derived from the calibration print to insure the precise movement of the sheet so it can be cut into individual prints.

Disposed between the buffer 16 and the entry cutter is a set of drive rollers 24, also referred to as ISL rollers 24. Preferably an entry stepper motor 26 under control of controller 14 activates the drive rollers. The function of drive rollers 24 is to deliver printed sheet 15 to the cutter. As noted hereinabove, the sheets may vary in length so it is important that the drive rollers be calibrated so that known increments in the rotation of the rollers produces a known linear translation of the sheet.

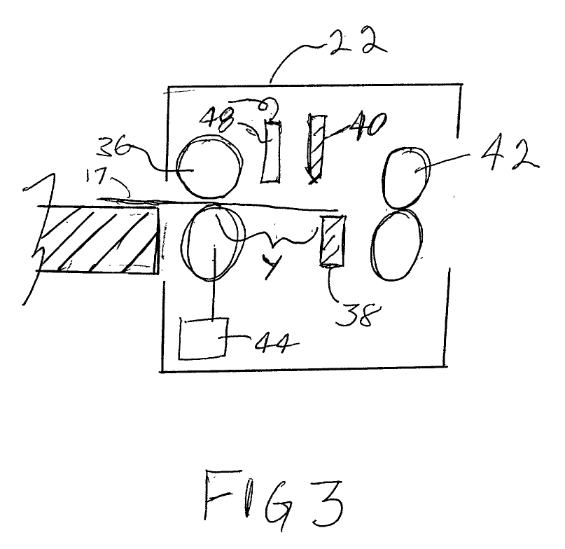

As shown in FIG. 2, entry cutter 18 includes an anvil 28 and a pair of registration rollers 30 just upstream of the anvil. The function of the registration rollers is to move the printed sheet received from the drive rollers 24 to the anvil so a knife 32 can be operated to sever a strip 17 from the printed sheet 15. This is accomplished by controllably driving the registration rollers using any suitable means such as a registration stepper motor 34 or the like under control of the controller 14. Individual strips 17 may be of different lengths so the registration rollers must move the sheet 15 into the cutter by an exact distance equal to the width of the strip to be severed from the sheet. This requires a first calibration to correlate the linear movement imparted by the registration rollers 30 with a known increment of the rotation of the registration rollers. Precise placement of the sheet for cutting it into strips also involves a proper registration of the sheet with respect to the anvil 28. This requires calibration of the distance “x” between the nip at the registration rollers and the anvil and a subsequent correction of the drive of the registration rollers (if necessary) so the drive can precisely match this distance.

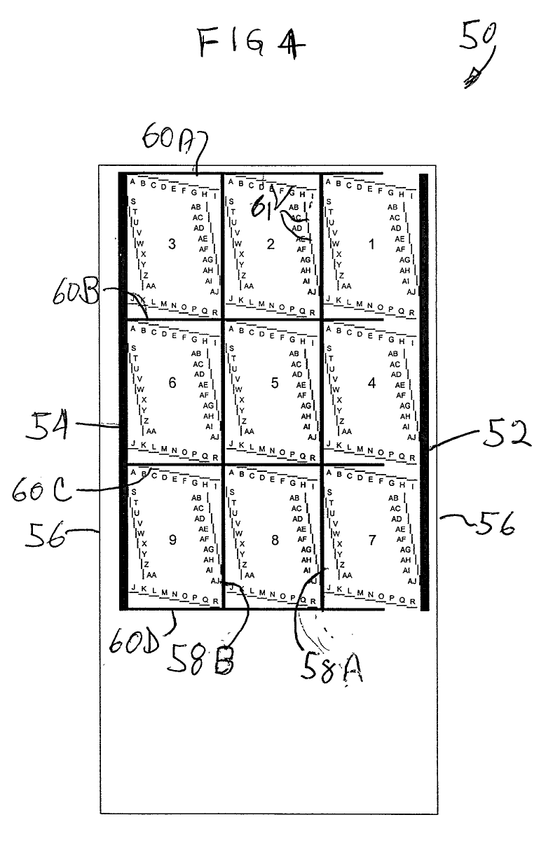

Located at the inlet to the exit cutter 22 is a set of exit registration rollers 36, also known as eighteen-inch registration drivers (FIG. 3). These registration drivers 36 are driven by a backside stepper motor 44 under control of the controller 14 must be calibrated for the same reasons as the calibration of the registration rollers 30 at the inlet cutter 18. The exit cutter also includes an anvil 38 and a knife 40 and a set of backside exit rollers 42 for pulling a severed print from the exit cutter. For reasons similar to those noted above, the distance “y” between the nip of the exit registration rollers and the anvil must be calibrated. To complete the construction, both the entry and exit cutters include a scanner 46, 48 respectively (see FIGS. 2 and 3). The scanners are disposed to detect certain fiducial indicators on a sheet of photographs entering the cutters 18, 22. The fiducial marks are applied to the sheet by the printer 12 in conjunction with the printing of the images. Detection of the fiducial marks result in the issuance of instructions by the controller 14 to a stepper motor in order to cause the positioning of the sheet at a proper cut location.

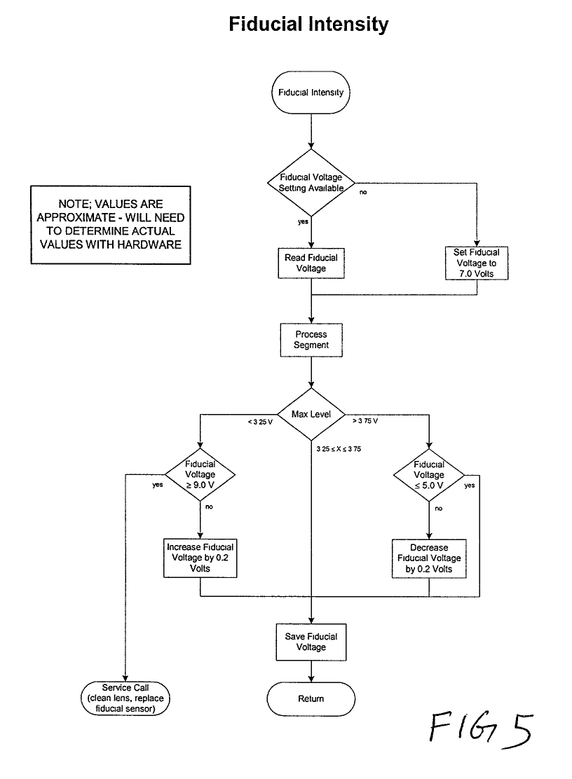

For purposes of insuring the proper operation of the stepper motors, the present invention provides for the calibration and adjustment of the stepper motors. This is accomplished by having the printer produce a calibration print that is subsequently passed through the drive rollers 24 and the cutter system. A calibration print generally indicated at 50 is shown in FIG. 4. As noted above, the calibration print is prepared by in the same printer 12 that generates the array of photographic prints comprising sheet 15. The markings on the calibration print produced by the printer include exit fiducial marks 52, 54 respectively extending longitudinally and generally parallel to the side edges 56 of the print. These longitudinal extending fiducial marks 52, 54 are spaced a known distance apart and define the lateral outer edges of a print field. Additional exit fiducial marks 58 A and B are located at equally spaced intervals across the calibration print.

The calibration print also includes spaced entry fiducial marks as shown at 60 A, B C and D that are disposed transverse the calibration print and orthogonal to the exit fiducial marks 52, 54, 58A and B. The entry fiducial marks are spaced a known distance apart and define the leading edges of print field subsets or rows extending across the calibration print. Thus the entry and exit fiducial marks together as shown in FIG. 4 define the boarders of print fields 1-9 wherein the print fields 1-3 make up a first row or subset, the print fields 4-6 make up a second row or subset and the print fields 7-9 make up a third row or subset. In addition to the longitudinal and transverse fiducial marks, the printer 12 prints a series of nine or more indicators 61 along the edges of each print field. The indicators are identified by alphabetical or numerical codes for easy reference and are progressively staggered inward from the adjacent edges of the print field for purposes set out hereinbelow. For reference purposes indicators 61A-I are leading entry cut indicators and indicators 61AB-AJ are leading exit cut indicators.

In accordance with present invention, proper operation of the cutters 18 and 22 require calibration of the parameters for the drive rollers 24, the registration rollers 30, the registration drivers 36 and the distances “x” and “y”. The calibration print 50 is used in the adjustment of these parameters.

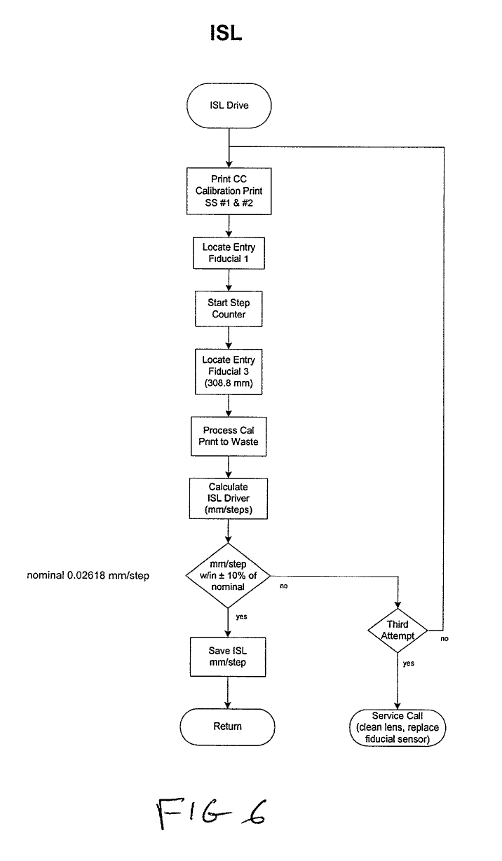

As a first step in the calibration process, sensors 46, 48 are adjusted to insure that the fiducial marks on the calibration print will be properly recognize by the sensor s ability to distinguish white versus dark. As shown in the diagram of FIG. 5, processing the calibration print through the sensors does this. If the calibration print is on white paper, properly illuminated and the sensor is working properly, then the sensor output voltage to signal the detection of a fiducial mark will be at a pre selected level, or 3.5 volts in the present example. An output voltage less than 3.25 volts signifies that there is insufficient illumination of the fiducial. In this case the illumination is increased. If, on the other hand, the output voltage is greater than 3.75 volts, the illumination is too intense and is decreased. The adjustment continues until the output voltage is in the acceptable range of 3.25 to 3.75 volts per the example. In this fashion the control circuit for the fiducial sensors 46, 48 can self correct to compensate for dust or other accumulations that reduces light to the sensors.

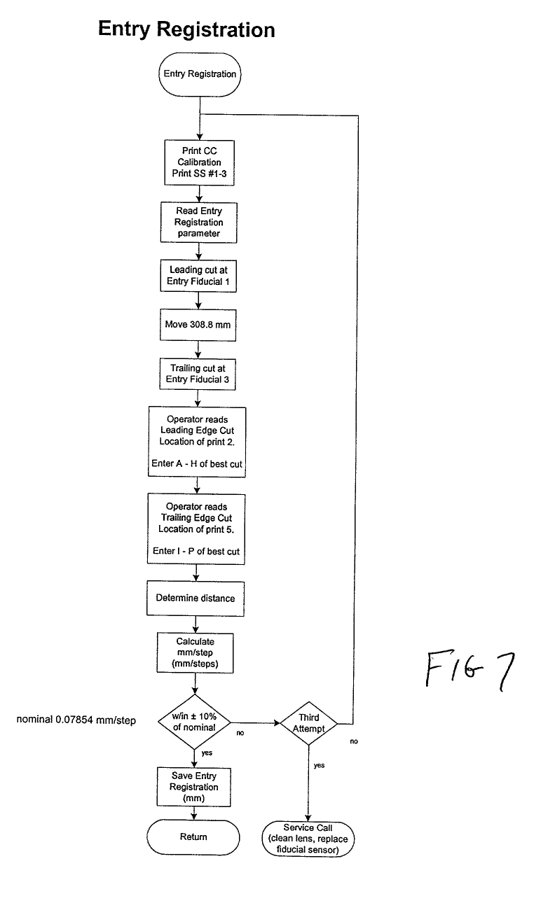

The next step is to calibrate the run of the set of drive rollers 24. It is the function of these rollers to move a sheet of photographs onto the entry cutter 18. Accordingly it is important that these rollers drive the sheet a known linear distance with each increment of revolution. As shown in the diagram of FIG. 6, a first step in the calibration of the drive rollers (as in all calibration steps) is the preparation of a calibration print 50. The print is prepared by the inkjet printer 12 under the direction of the controller 14. The printer is self-adjusting so all dimensions of the calibration print are known and are exact. The stepper motor 26 that drives the rollers 24 initially is set to a nominal value calculated to drive a sheet a given distance with each step. In the case of the example shown in FIG. 6, the distance is 0.02618 mm per step.

The stepper motor then is operated to drive the rollers 24 to move the calibration print 50 into the entry cutter 18 until the sensor 46 detects the first entry fiducial mark 60A. At this point a step counter is started. The drive continues to operate until the third entry fiducial mark 60C is detected. As the distance between the two entry fiducial marks 60A and 60C is a known distance, controller 14 merely has to compare the distance that the rollers are driven by the stepper motor (number of steps times 0.02618 mm) with the known distance between the two fiducial marks. If the driven distance is not within plus or minus 10% of nominal, the controller makes an adjustment in the linear distance moved with each step. In this fashion corrections are made to compensate for mechanical tolerances in manufacturing and for wear or factors that may cause a deviation of the drive rollers form the nominal value.

Next to be calibrated are the registration rollers 30 in the entry cutter 18. The function of the registration rollers, after the sensor 46 detects an entry fiducial mark, is to index a printed sheet a precise distance so as to locate the sheet at a proper cutting location. To accomplish an accurate placement of the printed sheet, two parameters must be calibrated. First the run of the registration rollers must be determined so the linear distance resulting from each increment of rotation is known. Next, the exact distance between the nip of the registration rollers and the anvil must be determined.

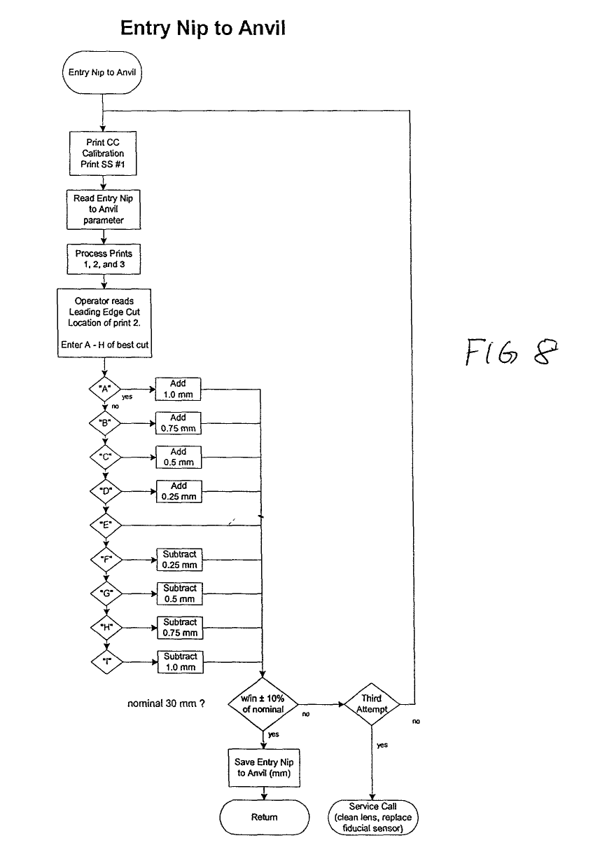

With reference to the diagram of FIG. 7, the run of the registration rollers is calibrated by moving the calibration print into the cutter until the sensor 46 detects the entry fiducial mark 60A. The distance from the leading edge of the calibration print to the first entry fiducial is known. Accordingly, after the first entry fiducial is detected, the registration rollers are stepped an amount theoretically calculated to place the first entry fiducial at the anvil 28. A first cut is made and the registration rollers are then stepped an amount calculated to place the third entry fiducial 60C at the anvil. A second cut is made. The operator then examines the location of the leading and trailing edge cuts in the region of prints 2 and 5 respectively. By visual inspection, the operator selects the closest leading indicator (A-I) of print 2 that is closest to the cut and does the same for the closest trailing indicator (L-R) of print 5 that is closest to the cut. The distance between the selected indicators is measured and is compared to the theoretical distance that the registration rollers moved the calibration print. If the actual and theoretical distances differ by more than plus or minus 10% of a nominal value, a correction of the stepper motor is indicated. In this fashion the drive of the registration rollers is corrected so each step or increment of rotation translates to a known increment of linear travel.

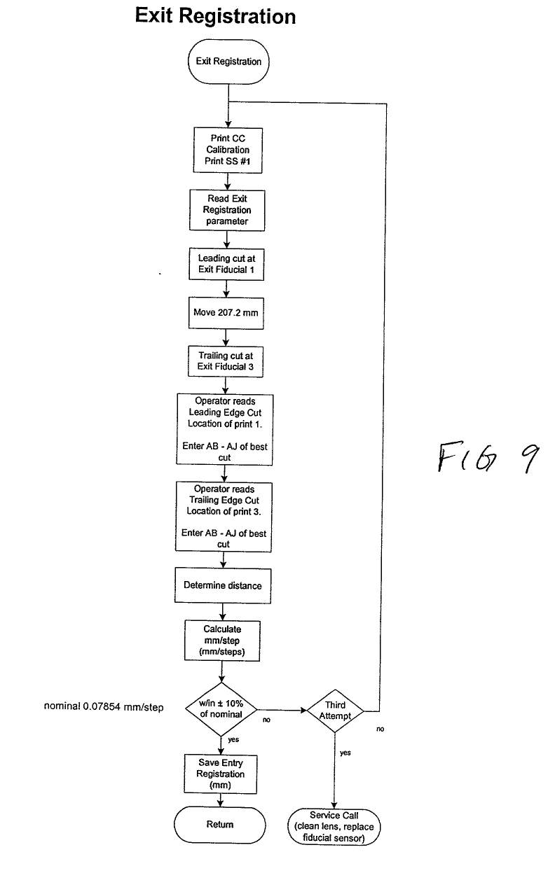

Once the run of the registration rollers is corrected, the exact distance “x” between the nip of the registration rollers and the anvil is calibrated. While the approximate distance is known form the manufacturing dimensions, it should be appreciated the exact distance may vary because of manufacturing tolerances, wear or other event that might cause a slight displacement of the anvil. The sequence for calibrating the nip to anvil distance (or more properly the nip to cutting position distance) is described with reference to the diagram of FIG. 8. After printing of the calibration print, the print is conducted to the nip at the registration rollers 30. The registration rollers next index the print a distance calculated to locate a given entry cut indicator 61A, namely the indicator “E” at the cut location. Indicator “E” is selected as the cut location because it represents the desired position of the leading edge of a printed photographic image on a printed sheet which also is a known distance form the leading edge of a printed sheet.

After indexing to the cut location, the print is held and the knife 32 is actuated to cut across the print. The operator then inspects the calibration print to determine the actual location of the cut. If the theoretical and actual distances are the same, the cut will pass along the leading indicator “E”. However, it is likely the cut instead will pass along one or another of the leading indicators A-D or F-H which means that the actual distance is either shorter or longer respectively than the theoretical distance. The operator merely has to input the location of the cut (indicator A-D or F-H) and a correction is made automatically. For example, as shown in FIG. 8 an input that the cut appears along the leading indicator “A” will add 1.0 mm to the theoretical distance between the registration roller nip and the anvil (cut location). Conversely, an input that the cut is along the leading indicator “I” will subtract 1.0 mm form the theoretical distance. In this manner the actual distance is calibrated so that the registration rollers 30 can be operated by the stepper motor 34 to precisely position a printed sheet at the correct cut location.

Next to be calibrated are the registration drivers 36 at the exit cutter 22. These rollers are calibrated in a fashion similar to the calibration of the registration rollers 30. It is the function of these rollers to move a strip of photographs cut from a printed sheet in a transverse direction into the exit cutter, which then cuts the strip into individual prints. Accordingly it is important that these rollers drive the strip a known linear distance with each increment of revolution.

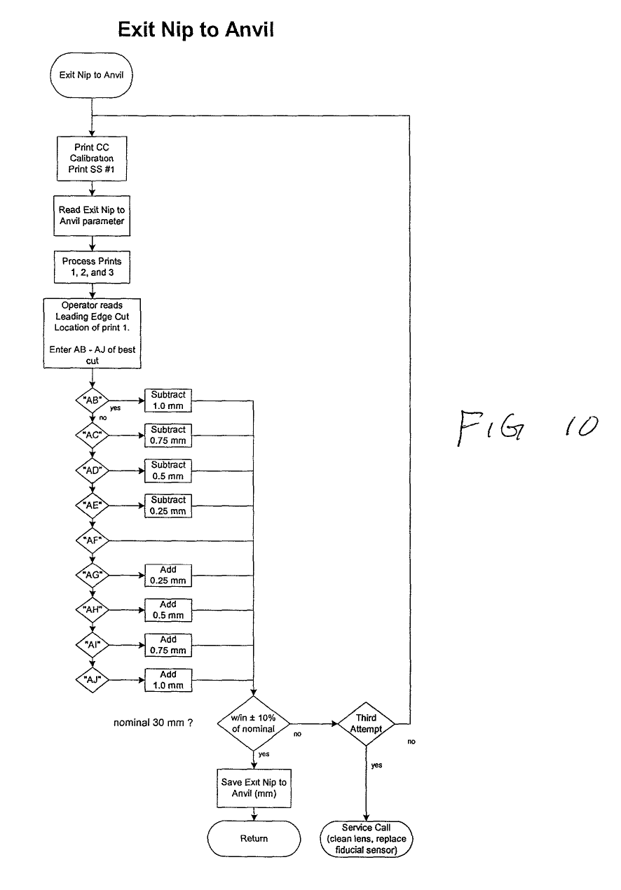

With reference to FIGS. 1 and 9, the calibration of the registration drivers 36 begins with the printing of a calibration print 50. The calibration print is delivered to the entry cutter 18, which severs a subset or strip from the calibration print by cutting first along the first entry fiducial 60A and then along the second entry fiducial 60B. The severed subset, comprising print fields 1, 2 and 3 is transported along the table 20 in the direction of arrow 21 (FIG. 1). The subset then is moved transversally in the direction of arrow 23 and to the nip of the exit drive rollers 36.

The run of the registration drivers 36 is calibrated by having the drivers move the calibration print into the cutter until the sensor 48 detects the exit fiducial mark 52. The registration drivers 36 are under the control of a stepper motor 44 (FIG. 3) initially set to move the subset a nominal 0.07854 mm per step. The distance from the lateral edge of the calibration print to the first exit fiducial is known. Accordingly, after the first exit fiducial is detected, the registration drivers are stepped an amount theoretically calculated to place the first exit fiducial 52 at the anvil 38 (cut location). A first cut is made and the registration drivers then are stepped an amount calculated to place the third exit fiducial 58C at the anvil. A second cut is made. The operator then examines the location of the first and second edge cuts in the region of prints 1 and 3 respectively. By visual inspection, the operator selects the closest indicator (AB-AJ) of print 1 that is closest to the cut and does the same for the closest indicator (AB-AJ) of print 3 that is closest to the cut. The distance between the selected indicators is measured and is compared to the theoretical distance that the registration drivers 36 moved the subset. If the actual and theoretical distances differ by more than plus or minus 10% of the nominal value, a correction of the stepper motor is indicated. In this fashion the run of the registration drivers 36 is corrected so each step or increment of rotation translates to a known increment of linear travel.

The last calibration involves determination of the distance between the anvil or cut location and the nip at the registration drivers 36. After a first cut is made along a side edge of a print, the function of the registration drivers is to move the print a suitable distance to locate the trailing side edge of the print at the cutting position. The run of the registration drivers is known from the previous calibration and the width of a print as generated by the inkjet printer 12 is known. Accordingly it only is necessary to determine with accuracy the distance between the anvil and the nip of the registration drivers. This is done in a fashion similar to the determination of the distance between the nip of the registration rollers 30 and the anvil 28. Only to do this the lateral indicators AB-AJ of a print field are used.

The sequence for calibrating the nip to anvil distance (or more properly the nip to cutting position distance) is described with reference to the diagram of FIG. 10. In this respect, the subset containing print fields 1, 2 and 3 is moved by the registration drivers a distance calculated to locate a given exit indicator AB-AJ, namely the indicator “AE” at the cut location. Indicator “AE” is selected as the cut location because it represents the desired position of the side edge of a printed photographic image on a printed sheet which also is a known distance form the side edge of a printed sheet.

After indexing to the cut location, the subset is held and the knife 40 is actuated to cut across the subset and establish an edge of the print field. The operator then inspects the calibration print to determine the actual location of the cut. If the theoretical and actual distances are the same, the cut will pass along the leading indicator “AE”. However, it is likely the cut instead will pass along one or another of the indicators AB-AD or AF-AJ which means that the actual distance is either shorter or longer respectively than the theoretical distance. The operator merely has to input the location of the cut (indicator AB-AD or AF-AJ) and a correction is made automatically. For example, as shown in FIG. 10 an input that the cut appears along the leading indicator “AB” will add 1.0 mm to the theoretical distance between the registration roller nip and the anvil (cut location). Conversely, an input that the cut is along the leading indicator “AJ” will subtract 1.0 mm form the theoretical distance. In this manner the actual distance is calibrated so that the registration drivers 36 can be operated by stepper motor 44 to precisely position a printed sheet at the correct cut location.

Thus it should be appreciated that the present invention provides, a method and apparatus for calibrating the drive of a cutter mechanism used in a photofinishing operation. The method relies on a printer generated calibrating print for adjusting the drives of a cutter mechanism used to sever individual prints from a sheet of photographs. The method allows for the comparing of a chosen feature of the calibration print to a pre set value and then adjusting the preset value as necessary to coincide with the chosen feature. In some cases the chosen feature is merely a measured distance between fiducial marks and in other cases the chosen feature is a cut length. While the invention has been described with reference to an operator comparing distances, making observation and entering inputs that result in a change of the operational parameters of the various stepper motors, it should be appreciated that a scanner can be provided for making the various readings. This would replace the various manual operations with a more automated system.

Having described the invention in detail what is claimed as new is:

1. A method for calibrating at least one adjustable drive of a cutter associated with an image printer comprising:
a) setting the adjustable drive of the cutter to a first setting;
b) printing a calibration print with the image printer;
c) moving the calibration print with the adjustable drive of the cutter;
d) comparing a chosen feature of the calibration print to the distance that the print is moved by the adjustable drive;
e) deriving an input signal representative of the difference between the chosen feature and the distance that the calibration print is moved by the adjustable drive; and
f) correcting the adjustable drive responsive to the input signal.

2. A method as in claim 1 including cutting the calibration print and the chosen feature is the cut length.

3. A method as in claim 1 wherein the adjustable drive is a stepper motor.

4. A method as in claim 3 wherein setting the adjustable drive is a stepper motor and setting the adjustable drive comprises setting the linear distance that the stepper motor moves the calibration print with each step.

5. A method as in claim 2 wherein correcting the adjustable drive comprises changing the distance a stepper motor advances the calibration print for cutting the calibration print.

6. A method as in claim 1 wherein the calibration print includes a pair of spaced fiducial marks and the chosen feature is the distance between the fiducial marks.

7. A method as in claim 1 wherein the calibration print includes a plurality of staggered fiducial marks; cutting the calibration print to provide a cut edge adjacent one of the fiducial marks and the chosen feature being the fiducial mark closest to the cut edge.

8. A method for calibrating at least one component of a cutter associated with an image printer comprising:
a) setting the adjustable component of the cutter to a first setting;
b) printing a calibration print with the image printer;
c) scanning the calibration print and measuring a feature of the calibration print that is affected by the setting of the adjustable component; and
d) adjusting the component in response to the measurement.

9. A method as in claim 8 wherein adjusting the component comprises setting a stored value in a controller operating the cutter.

10. A method as in claim 9 wherein the adjustable component comprises is the linear distance the calibration print is moved with each step of a stepper motor.

11. A method as in claim 8 including cutting the calibration print and scanning the print involves measuring the cut length of the calibration print and adjusting the component in response to the measured cut length.

12. A method as in claim 8 wherein the calibration print has at least one fiducial mark and said scanning measures the intensity of the fiducial mark and adjusting the component comprises setting a fiducial sensor to produce a predetermined output.

13. A method as in claim 8 wherein the adjustable component comprises an adjustable drive for moving the calibration print, the calibration print comprises first and second fiducial marks and said adjusting comprises adjusting the drive so the linear distance the drive moves the print corresponds to the distance between the fiducial marks.

14. A method as in claim 8 wherein the adjustable component comprises an adjustable drive for advancing the calibration print a preselected distance with respect to a cutter, the calibration print comprises a plurality of fiducial marks spaced a predetermined distances from a edge of the calibration print, and said adjusting comprises adjusting the adjustable drive to cause the cutter to cut the print at a predetermined one of the fiducial marks.
